(19) United States
(12) Patent Application Publication
(10) Pub. No.: US 2015/0059087 A1
(43) Pub. Date: Mar. 5, 2015

(54) PHYSICAL AID DEVICE WITH A HOLDER

(71) Applicant: Åsa Brännström, Lulea (SE)

(72) Inventor: Åsa Brännström, Lulea (SE)

(73) Assignee: HANDICARE AB, Järfälla (SE)

(21) Appl. No.: 14/378,658

(22) PCT Filed: Feb. 15, 2012
(86) PCT No.: PCT/SE2012/050160

§ 371 Date: Oct. 23, 2014

(51) Int. Cl. A61G 7/10

(52) U.S. Cl. CPC A61G 7/1046
USPC 5/86.1

(57) ABSTRACT

The present invention relates to an aid device for raising, rotation and transfer of a user, comprising a holder for receiving a strap connected to a belt which is worn by the user. The aid device comprises a base plate, for placement of the feet of the user, and a supporting device that is connected to the base plate, for supporting the user during the raising, rotation and/or transfer. The supporting device comprises a ladder portion having at least a first and a second graspable rung for aiding the user during the raising, rotation and/or transfer. It further comprises a holder for releasably holding a strap connected to the user. The holder projects from the first graspable rung towards the second graspable rung such that a gap is formed between a projecting end of the holder and the second graspable rung.

### FIELD OF THE INVENTION

The present invention relates to a physical aid device for raising, rotation and transfer of a user. The aid device comprises a base plate and a supporting device which is connected to the base plate and which is equipped with rise-to-stand aids.

### BACKGROUND OF THE INVENTION

Devices for assisting a disabled or elderly person to rise from a sitting position to a standing position include manual as well as motor driven devices. For users that do still have some strength and ability to rise a manual aid is advantageous since it stimulates the user's ability to move and strengthens his or hers muscles. Such an aid is therefore not only useful as a standing aid but also as a training device. In addition such an aid device is often easy to use and also spare the back, muscles and joints of the assisting person aiding the user to stand. Often a belt or a harness is used with the aid device, to aid in the raising and/or to stabilize the user once in upright position.

One such aid device is known from a product that is marketed by Handicare AB under the trademark “ReTurn”. It comprises a base plate which is arranged to be aligned with the floor and is equipped with wheels. A support frame is connected to the base plate at an upright, slightly forward leaning position. The support frame is provided with rise-to-stand aids in the form of graspable handles and lower-leg supports. The graspable handles are arranged as horizontal bars with a distance between, such that the support frame with the graspable handles forms a ladder portion. When in use, the user places his leg against the lower-leg supports, leans forward and by means of arm power pulls himself up by grasping the graspable handles. The ladder of graspable handles can be used to facilitate the raising, by the user grasping the graspable handles one at the time until standing. Vertical bars may also be arranged between the graspable handles, to enable grasping at different angles. Once in standing position the assisting person may rotate and/or transfer the user, by means of the wheels of the base plate, while the user is standing on the aid device. An assistant may thus use the aid device to move or transfer the person that needs assistance, e.g. from a bed to a wheelchair or from a wheelchair to a WC or any other transfer situation.

A belt may be worn by the user and used with the described aid device. The assistant may help the user by pulling the belt towards the support frame in order to position the user into a standing position. Once in the standing position, the belt may also be secured to the support frame in order to facilitate a standing position for the user. The belt may also include straps with fastening means for securing the belt to the user, wherein the straps and fastening means are adjusted to circumferentially adapt the belt to that of the user, e.g. for comfort reasons. When in standing position, the straps and fastening means of the belt may then be secured and locked to the support frame by a locking mechanism, such as a snap lock arrangement, a side release buckle or other type of buckle. Alternatively, the strap and fastening means may be tied around the support frame.

A drawback with this known aid device is that the securing of the belt and/or belt straps to the support frame is a demanding operation both for the assistant and the user. The securing is a multi-step operation during which the assistant also needs to ensure that the user is kept in the standing or upright position. The securing operation is also demanding for the user requiring him/her to balance in the standing or upright position on the base plate.

### SUMMARY OF THE INVENTION

The object of the invention is therefore to provide an aid device to which a user can be secured in an easy and safe manner.

This and other objects of the present invention are achieved by means of an aid device having the features defined in the independent claims. Embodiments of the present invention are characterized in the dependent claims.

The invention is based on the insight that by attaching a holder to the support frame and arrange the holder such that a gap is formed between a projecting end thereof and a portion of the support frame the belt strap or any strap attached to the belt may easily be passed over and/or around it, and at the same time provide a reliable and safe holding or securing of the belt to the support frame. Thus, the gap is sufficiently large or wide to releasably pass over and/or around the strap connected to the user and at the same time sufficiently small or narrow to hold the belt strap or any strap attached to the belt in position and/or secured to the support frame during the transfer operation. The holder and its arrangement relative to the support frame, i.e. the gap, thus both simplify the attachment and/or securing step of the belt to the aid device and also facilitate the supporting of the user. With such a holder the belt strap or any strap attached thereto is connected to the holder, the securing of the user to the aid device may be made by a simple one-hand manoeuvre or operation. This simple connection of the strap to the aid device may be performed by the assisting person or even by the user himself. Since the holder is positioned adjacent to and beneath another structure of the support frame, such as a graspable handle, a narrow gap is formed between the holder and the support frame structure, the belt strap or any other strap attached to the belt is prevented from being released from the holder unintentionally.

In the present application text the term “holder” relates to a structure over which a belt strap or any other strap attached thereto can easily be hooked onto or passed over and/or around it for holding the belt strap or any other strap attached thereto in position relative the support frame and aid device.

According to a first aspect the invention provides an aid device for raising, rotation and transfer of a user. The aid device comprises a base plate and a supporting device that is connected to the base plate. The base plate is arranged to receive the feet of the user during the raising, rotation and/or transfer and is preferably arranged such that the user is correctly positioned in relation to the supporting device, to facilitate the raising. In addition, the base plate is preferably arranged with wheels, such that the aid device, and the user standing on the aid device, can be transferred over the floor. The supporting device is arranged for supporting the user during the raising, rotation and/or transfer, by comprising rise-to stand aids that aid the user during the raising, and by being a support against which the user can lean once in a standing position. The supporting device comprises a ladder portion having at least a lower graspable rung and an upper graspable rung, for aiding the user during the raising, rotation and/or transfer. Herein, the lower graspable rung is alternatively denoted a first graspable rung, and the upper graspable rung alternatively denoted a second graspable rung. They may also be denoted graspable handles. The graspable rungs are substantially horizontally arranged bars that are positioned at a distance from each other, the lower graspable rung being positioned more proximate to the base plate and the upper graspable rung being positioned more distant from the base plate. By such an arrangement the graspable rungs together form a ladder like portion. The graspable rungs can be used by the user to climb the ladder portion by use of his hands, thereby pulling him up to a standing position. The arrangement of the graspable rungs in the ladder portion thus allows the user to use not only his leg strength, but also his arm strength in the raising. Thereby the raising is greatly facilitated.

The supporting device further comprises a holder for releasably holding a strap or a similar object, such as a string or a rope, connected to the belt or the user. The holder is thus a holding, attachment or connection device, to or on which the strap or similar object can be temporarily connected, or by which the strap or similar object can be temporarily retained or held.

The holder is arranged such that a strap or the like can easily be passed over it, and such that a strap or the like can be arranged around it so that the strap or the like is held in position. Preferably the strap or the like can be passed over and connected to the holder by a one-hand manoeuvre. The holder may be arranged to hold the strap by means of gravity and/or tension. For instance, the strap may in a first state, e.g. when the user is standing on his own motion, be held by means of gravity. In a second state, e.g. when the user is in need of support by the supporting holder, or is actually about to fall, and the strap is either intentionally tightened or pulled by the movement of the user, the strap is held to the holder by tension. The holder is for instance shaped as protruding portion over and around which the strap can easily be passed or pulled. In one embodiment the holder comprises a pin, peg, catch, a stem, or any protruding portion, e.g. a hook or a bulb or sphere or similar, attached to the first graspable rung, and over which the strap can easily be passed. In another embodiment the holder comprises two pins, pegs, catches or protruding portions that are attached to the first graspable rung and that are arranged in a V-shaped configuration. The advantage of a holder as described is that it allows the strap or the like, and thus the user, to be easily connected to the supporting post, and then easily released again. A simple movement by the assisting person, possibly using only one hand, by which the strap is passed over the holder, is all that is needed. Handling of snap lock arrangements, buckles or other more complicated means of attachment is avoided. Also, the strap, belt or supporting device need not be arranged with buckles or such devices. The simple movement by which the strap is connected to the holder shortens the time during which the user is in a position where he is not secured to the supporting post and during which he may fall.

The holder projects or protrudes from the lower, i.e. first, graspable rung towards the upper, i.e. second, graspable rung such that a gap is formed between a projecting end of the holder and the upper graspable rung. In other words, the holder projects from the lower graspable rung upwards towards the upper graspable rung. In one embodiment the holder projects substantially perpendicularly from the lower graspable rung. The end of the holder that is most distant from the lower graspable rung, i.e. closest to the upper graspable rung, is the projecting end of the holder. The holder projects towards the upper graspable rung but does not meet or connect to the upper graspable rung. In other words, there is a distance, i.e. a gap, between the projecting end and the upper graspable rung. This gap is arranged to allow a strap or similar to be passed between the holder and the upper graspable rung and, more importantly, to be passed over the holder.

In order to ensure that the strap is not unintentionally released from the holder during the raising, rotation and/or transfer the gap may comprise a width that is sufficiently narrow to prevent release. For example, the gap may be sufficiently narrow in relation to the thickness and/or width of the strap that is intended to be used. The width of the gap is slightly wider than the thickness of the strap up to double the thickness of the strap. Normally, in this field, the straps used have a thickness of approximately 0.3-1 cm. The width of the gap is approximately 0.5-2 cm.

The holder may further comprise a mechanical stop portion for preventing the strap from even further being unintentionally released from the holder. Such mechanical stop portion may be arranged such that it forms the projecting end of the holder. The mechanical stop portion comprises a shape or a portion having a larger or wider size, dimension or circumference than that of a main holding portion of the holder. Thereby, the larger or wider size, dimension or circumference of the mechanical stop portion mechanically prevents or blocks the strap from sliding off the holder. It may for instance comprise an element having a cross section area larger than that of the main holding portion of the holder or a hook.

In one embodiment the supporting device of the present invention comprises a supporting post which at one end is detachably connected to the base plate and at the other end comprises the ladder portion. In another embodiment the supporting device comprises two parallel supporting posts which at one end are detachably connected to the support base, and which at the other end comprise graspable rungs extending between the supporting posts, thereby forming the ladder portion.

The ladder portion may further comprise at least one graspable bar that interconnects the graspable rungs of the ladder portion.

According to a second aspect the invention provides a system for raising, rotation and transfer of a user, comprising an aid device according to the present invention and a user belt that is arranged to be secured to the holder of the aid device. The user belt may comprise at least one support band for supporting the waist of the user and/or a belt strap arrangement that for securing the belt to the user and that is adjustable to the size of the user. The belt strap arrangement is in a preferred embodiment further arranged to be pulled over and/or around said holder during the raising, rotation and/or transfer of the user.

### BRIEF DESCRIPTION OF THE DRAWINGS

Embodiments of the present invention will now be described as non-limiting examples and with reference to the accompanying figures in which

FIG. 1 shows a first embodiment of an aid device according to the present invention.

FIG. 2 shows a second embodiment of an aid device according to the present invention.

FIG. 3a and b show further embodiments of an aid device according to the present invention.

FIG. 4a and b show different embodiments of a supporting device according to the present invention.

FIG. 5a and b show further embodiments of a supporting device according to the present invention.

FIG. 6a and b show close-ups of different embodiments of ladder portions according to the present invention.

### DETAILED DESCRIPTION

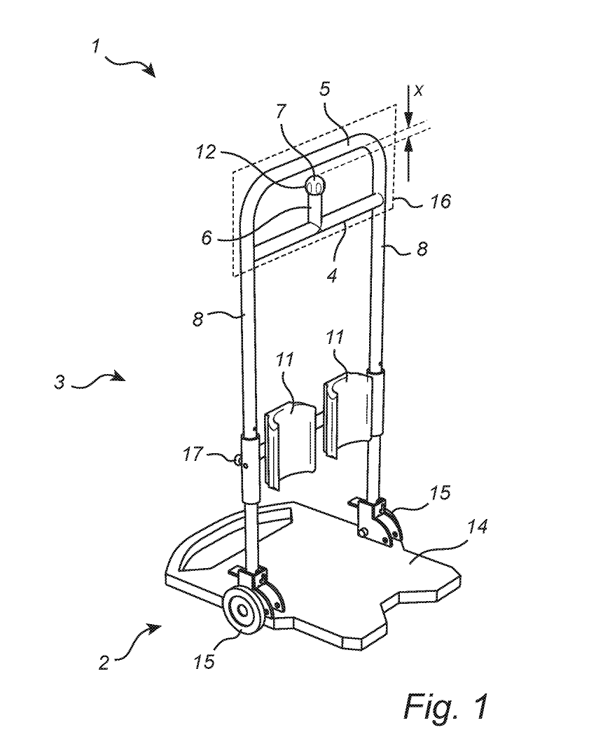

FIGS. 1, 2 and 3 show different embodiments of an aid device according to the invention. The aid device 1 comprises a base plate 2 and a supporting device 3. The base plate 2 is configured for the user to stand on and to provide stability and support to the supporting device 3, as well as to enable movement of the aid device over a surface of a floor. The supporting device 3 is configured to aid the user during raising, turning and transfer, by comprising rise-to-stand aids that are used during the rising motion and by comprising a structure that the user can lean against during rotation and transfer.

The base plate 2 comprises an upper surface 14 on which the user can place his feet and stand during raising, rotation and transfer. The upper surface 14 comprises an area for placement of the feet, which is free from any upright components, such that there is nothing to obstruct the feet of the user. The base plate 2 also comprises wheels 15 that allow the device aid to be rotated and transferred over the floor. Arrangement of the base plate and its wheels has for instance been disclosed in patent document WO 2004/075805 A1. The base plate 2 is advantageously made of a material with inherent anti-slip properties.

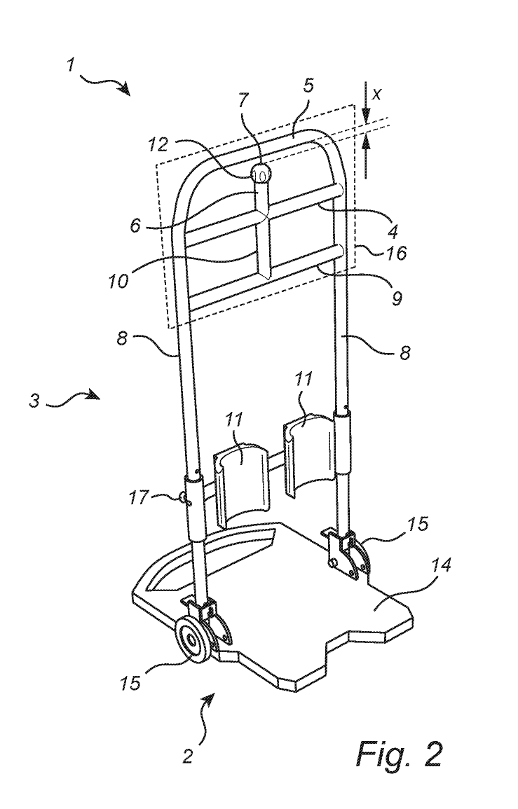

In the embodiments shown in FIGS. 1 and 2 the supporting device 3 is arranged as a supporting frame having two parallel supporting posts 8 of a tubular structure, which at their one end are connected to the base plate 2. At the other end, i.e. the end facing away from the base plate 2, the supporting frame comprises a ladder portion 16 wherein an upper portion of the supporting posts 8 form the vertical side portions of the ladder. The rungs of the ladder are formed by graspable rungs 4, 5, 9 that interconnect the supporting posts 8. The graspable rungs 4, 5, 9 serve as rise-to-stand aids in the form of handles that the user can grasp while rising. By “climbing” the graspable rungs 4, 5, 9 with his hands, the user may pull himself up one step at a time. The graspable rungs 4, 5, 9 are thus arranged to enable the user to grasp them and are dimensioned accordingly.

The supporting device 3 of the aid device 1 in FIG. 1 comprises two graspable rungs 4, 5. Such a supporting device 3 is advantageously provided for use by children and short adults. For such users the difference in height between a sitting and a standing position is smaller than for taller persons. Once the user is in a standing position he uses the supporting device 3 to lean against and the upper graspable rung 5 to hold on to. The upper graspable rung 5 is therefore preferably situated at a height that is comfortable and ergonomically correct for the user when he is in a standing position. Thus, the height of the supporting device 3 is preferably shorter for an aid device 1 for use by shorter persons. Also, since the vertical distance or height for “climbing” with the hands, to get to an upright position, is often shorter for short persons, two graspable rungs 4, 5 may be sufficient.

The supporting device 3 of the aid device in FIG. 2 comprises three graspable rungs 4, 5, 9. Such a supporting device 3 is advantageously provided for use by taller persons. For such users the difference in height between a sitting and a standing position is larger than for shorter persons and the upper graspable rung 5 is preferably situated at a higher height to be comfortable to lean against and hold on to in a standing position. Therefore, the height of the supporting device 3 is preferably longer for an aid device 1 for use by taller persons. Also, since the height for “climbing” with the hands is often longer for taller persons, three or more graspable rungs 4, 5, 9 may be necessary or appropriate.

In an alternative embodiment the height of the supporting device 3 is adjustable, allowing the aid device 1 to be used by and adjusted to both children and short and tall adults. The graspable rungs 4, 5, 9 may also be displaceably mounted to the supporting post or posts 8, such that the position of the graspable rungs 4, 5, 9 can be adapted to the size and configuration of the user.

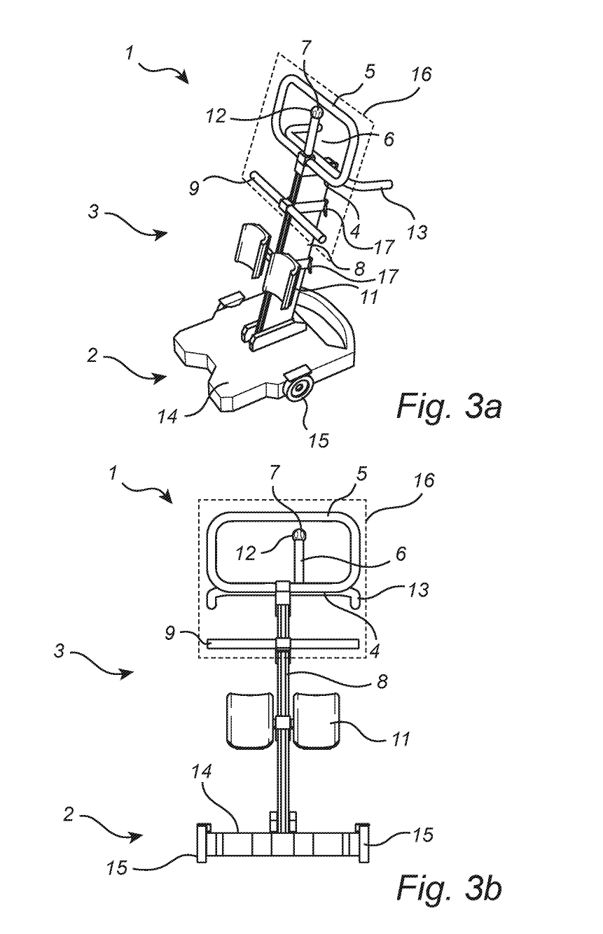

In the embodiments shown in FIG. 3 a) and b) the supporting device 3 comprises a single supporting post 8 centrally mounted on the base plate 2. In operation the user stands with one foot on each side of the supporting post 8, which forces the user to place his feet slightly apart, ensuring a good and safe position as the user stands up. At the end of the supporting post 8 facing away from the base plate 2 the supporting device 3 is arranged with a ladder portion 16 comprising graspable rungs 4, 5, 9 corresponding to the graspable rungs 4, 5, 9 described above. The graspable rungs 4, 5, 9 are arranged as rise-to-stand aids by which the user may pull himself up from a sitting to a standing position, as has been described.

The supporting post 8 shown in FIG. 3 has a rectangular cross-section with two long sides and two short sides, and is oriented such that the long sides are perpendicular to the axis between the wheels 15. As a result, the supporting post 8 efficiently absorbs the forces from a user pulling himself up by means of the supporting post 8 or leaning against the supporting post 8. Also, the torque exerted by an assistant person on the supporting post 8, when he wants to rotate or steer the aid device, is efficiently transferred to the base plate 2 and the wheels 15.

It is to be understood that the supporting device 3 of the present invention may also have other configurations. For instance, the supporting device 3 may comprise three and possibly more supporting posts 8, as long as the attachment of the supporting device 3 to the base plate 2 allows for placement of the user's feet on the base plate 2. Also, the supporting posts 8 may have alternative configurations, e.g. having cross-sections that are not only circular or rectangular but that are of other shapes. Any configuration of the supporting device 3 providing stability to the user during raising and standing and providing space for the feet as well as for the rising motion is conceivable. Importantly, the supporting device 3 comprises a ladder portion 16 with two, three or more graspable rungs 4, 5, 9 for aiding the user during rising.

The height of the supporting device 3 is approximately 85-135 cm, the lower portion of the interval being suitable for short persons and children and the upper portion of the interval being suitable for tall persons. In one embodiment the height of the supporting device 3 is approximately 85-105 cm and in another embodiment the height of the supporting device 3 is approximately 115-135 cm. The height or vertical distance between the graspable rungs 4, 5, 9 is approximately 10-20 cm, preferably 12-15 cm.

The supporting device 3 is connected to the base plate 2 such that it is inclined with respect to a vertical plane that is perpendicular to the floor on which the aid device is situated. In other words it is connected to the base plate 2 such that it leans forward, when viewed from the position of the user. The inclination is approximately 15-17° to a vertical plane, i.e. a plane that is perpendicular to the floor. This inclination is ergonomically advantageous when a user is to pull himself up from a sitting to a standing position. Moreover, this inclination provides stability to the aid device 1 when the user is standing on the base plate 2 and holding on to or leaning against the supporting device 3. The angle of inclination may vary depending on where on the base plate 2 the support device 3 is positioned. If the supporting device 3 is positioned close to the edge of the base plate 2 facing the side at which the user is to be situated the angle of inclination can be increased. If the supporting device 3 is positioned closer to the axis of the wheels 15 the angle of inclination may be decreased.

The supporting device 3 may be detachably connected to the base plate, facilitating disassembly and transportation of the aid device 1.

As is shown in FIGS. 1, 2 and 3 the supporting device 3 may also comprise rise-to-stand aids in the form of lower-leg supports 11. Such lower-leg supports are cup shaped and configured to receive the lower part of the user's leg, i.e. the shin and/or part of the knee. The user may thus, during the raising, get extra support and help using his legs by bracing his lower legs against the lower-leg support 11.

The lower-leg supports 11 may be displaceably mounted to the supporting post 8, such that the position of the lower-leg supports 11 can be adapted to the size and configuration of the user. It is also advantageous to arrange the lower-leg supports 11 such that their inclination can be varied, so as to enable contact with the user's leg continuously throughout the raising and standing. The lower-leg supports preferably have raised outer anti-slip edges so that the user's lower legs will not slide out during or after rising.

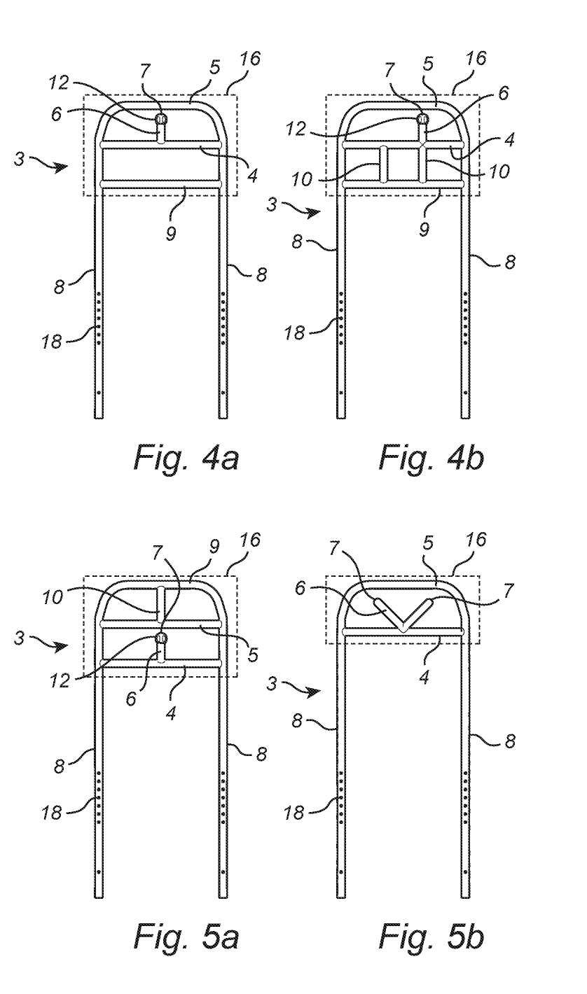

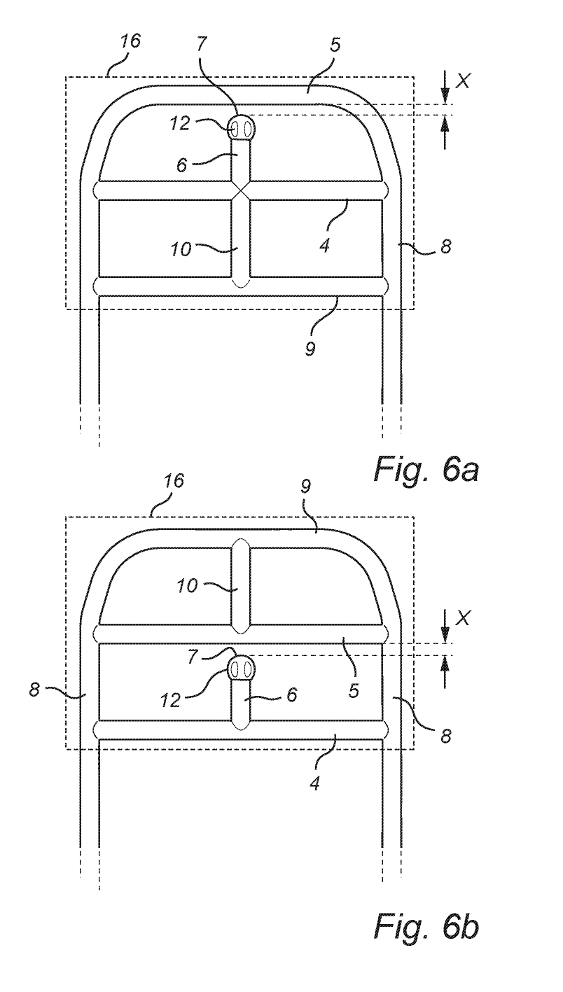

In embodiments where the rise-to-stand aids, i.e. graspable rungs 4, 5, 9 and/or lower-leg supports 11, are displaceably mounted to the supporting post(s) 8, the graspable rungs 4, 5, 9 and/or lower-leg supports 11 may be provided with a locking device 17 such as locking levers (FIG. 3) or locking pins (FIGS. 1 and 2). The locking device 17 is used to lock the rise-to-stand aid in a position that is suitable for a particular user. The supporting post 8 is then arranged with corresponding means 18, e.g. recesses (FIG. 4-5) that work in interaction with the locking device 17 to enable the displacement and the locking.

The supporting device 3 may also, in some embodiments, be arranged with moving handles 13 (FIG. 3). They are provided on the side of the supporting device 3 that is opposite to the side that is arranged for positioning of the user. The moving handles 13 are provided to be used by the assisting person, in order to facilitate rotation and transfer of the aid device 1 over the floor.

The supporting device 3 of the present invention is provided with a holder 6 that is arranged to receive and releasably hold a strap that is connected to the user, in order to secure the user to the supporting device 3 during the raising, rotation and/or transfer. The user may for instance carry a belt, a harness or a similar device around his waist, seat and/or lumbar area, to which a strap or straps are attached or connected. By anchoring the strap(s) connected to the user to the holder 6 of the supporting device 3, the user is firmly supported by the supporting device 3 while standing on the aid device 1. The connection between the belt or similar device, the straps and the holder 6 prevents the user from sitting or falling to the sides during the rotation and/or transfer of the aid device 1 (FIG. 7).

In order to facilitate the connection of the strap to the supporting device 3 the holder 6 is preferably arranged such that the strap can easily be pulled over the holder 6, preferably with a one hand grip. In order to further facilitate the attachment of the strap to the holder 6, the holder 6 is preferably also arranged such that the strap is held or retained by the holder 6 by tension. The holder 6 may for instance comprise a protruding portion such as a pin, a peg or a stem or a protruding portion that is circular or of any other shape, e.g. a bulb or a sphere, allowing the strap to be pulled around it and allowing the strap to be retained by it by tension. Alternatively the holder 6 may comprise two or more protruding portions over and around which the strap can be pulled and by which it can be retained by tension. FIG. 5b, for example, shows a supporting device 3 comprising a holder 6 with two pins that are arranged in a V-shaped configuration. Corresponding holders 6 where the protruding portions have other shapes are also conceivable.

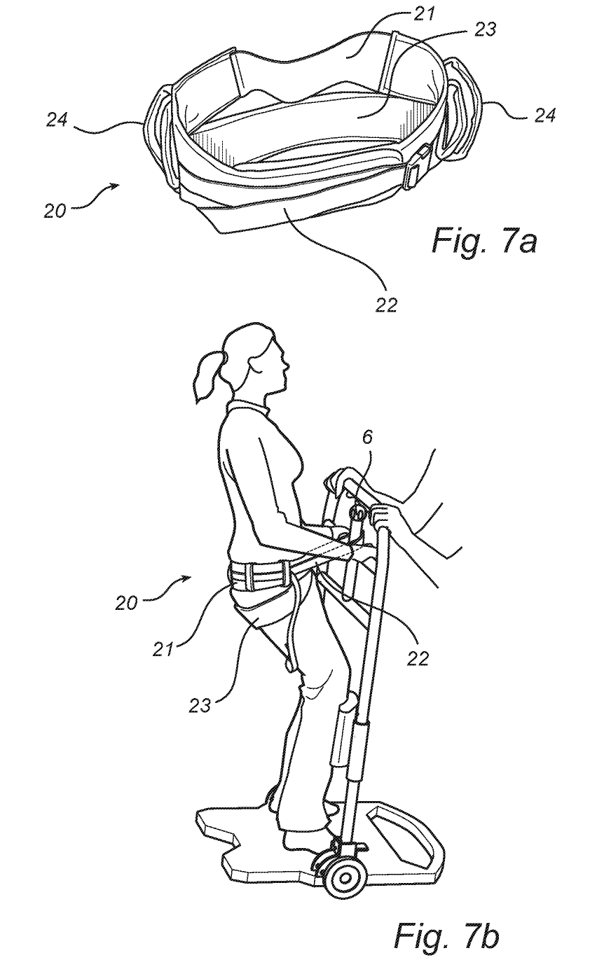

In order to prevent the strap from unintentionally being released from the holder 6, the holder 6 is arranged on a lower graspable rung 4 and projects towards an upper graspable rung 5, such that a gap is formed between a projecting end 7 of the holder 6 and the upper graspable rung 5. When the width x of the gap is sufficiently narrow, e.g. in comparison with the thickness of the strap, the strap is prevented from being unintentionally released from the holder 6 (FIG. 6). The width x of the gap is preferably approximately 0.5-2 cm.

The holder 6 may also comprise a mechanical stop portion 12 that further prevents the strap from being unintentionally released from the holder 6. The mechanical stop portion 12 may for instance be arranged at the projecting end 7 of the holder 6. In the embodiments shown in FIGS. 1-6 the mechanical stop portion 12 comprises a sphere shaped element having a larger cross section area than a main holding portion of the holder 6. The sphere shaped element prevents the strap from sliding off the holder 6. The mechanical stop portion 12 may alternatively be provided as a hook on the protruding portion, or may be an element of any geometrical shape, e.g. cubic, flat or irregular, having a cross section area that is larger than that of the protruding portion.

The holder 6 may be positioned at various positions of the ladder portion 16 of the supporting device. The holder 6 is positioned such that it projects from a lower graspable rung 4 towards an upper graspable rung 5, i.e. such that it has at least one graspable rung 5 positioned above it and such that a gap is formed between a projecting end 7 of the holder 6 and the upper graspable rung 5. It may for instance be positioned at the lowest graspable rung 4 of the ladder, as shown in FIGS. 1, 5a and 5b. Alternatively, it may be positioned at a lower, but not lowest, graspable rung 4 of the ladder, as shown in FIGS. 2, 3 and 4. The ladder portion 16 of the supporting device 3 may also comprise one or more additional graspable rungs 9, that is/are positioned either below the lower graspable rung (FIGS. 2, 3 and 4) or above the upper graspable rung 5 (FIG. 5a).

The holder 6 may be positioned at a central position of the lower graspable rung 4, or may be positioned displaced from the central position, as shown in FIGS. 3b and 4b.

The supporting device 3 may further comprise one or more graspable bars 10 that extend between and interconnect the graspable rungs 4, 5, 9. The graspable bars may extend vertically between the graspable rungs 4, 5, 9, or may extend at any other angle. The graspable bars 10 provide further sites and angles at which the user can place his hands for support and to pull himself up during raising, standing, turning and transfer.

Exemplifying embodiments of aid devices 1 and supporting devices 3 according to the present invention are shown in FIGS. 1-5. FIG. 1 shows a supporting device 3 having two supporting posts 8 and a ladder portion 16 with two graspable rungs; a lower graspable rung 4 and an upper graspable rung 5. The holder 6 is positioned at a central position of the lower graspable rung 4 and projects towards the upper graspable rung 5. The holder 6 comprises a mechanical stop portion 12 and a projecting end 7. A gap with a width x is formed between the projecting end 7 and the upper graspable rung 5.

FIG. 2 shows a supporting device 3 having two supporting posts and a ladder portion 16 with three graspable rungs; a lower graspable rung 4, an upper graspable rung 5 and an additional graspable rung 9 placed below the lower graspable rung 4. The holder 6 is positioned at a central position of the lower graspable rung 4 and projects towards the upper graspable rung 5. It comprises a mechanical stop portion 12 and a projecting end 7. A gap with a width x is formed between the projecting end 7 and the upper graspable rung 5. A graspable bar 10 extends between the lower graspable rung 4 and the additional graspable rung 9.

FIG. 3a and b show supporting devices with one supporting post 8 and a ladder portion 16 with three graspable rungs; a lower graspable rung 4, an upper graspable rung 5 and an additional graspable rung 9 placed below the lower graspable rung 4. In FIG. 3a the holder 6 is positioned at a central position of the lower graspable rung 4, while in FIG. 3b the holder 6 is positioned at a position offset from the central position. In both figures the holder 6 projects towards the upper graspable rung 5 and comprises a mechanical stop portion 12. A gap is formed between the mechanical stop portion 12 and the upper graspable rung 5. In the embodiments of FIG. 3 the supporting device 3 also comprises moving handles.

All aid devices 1 of FIGS. 1-3 further comprise a base plate 2 and lower-leg supports 11.

FIGS. 4-5 disclose exemplifying supporting devices 3 of the present invention, which are separated from the base plates 2 of the aid device 1.

FIG. 4a and b both show supporting devices 3 having two supporting posts and a ladder portion 16 with three graspable rungs; a lower graspable rung 4, an upper graspable rung 5 and an additional graspable rung 9 placed below the lower graspable rung 4. In FIG. 4a the holder 6 is positioned at a central position of the lower graspable rung 4 while in FIG. 4b the holder 6 is positioned at a position displaced from the central position. In both figures the holder 6 projects towards the upper graspable rung 5 and comprises a mechanical stop portion 12. A gap is formed between the mechanical stop portion 12 and the upper graspable rung 5. The supporting device 3 in FIG. 4b comprises two graspable bars 10 that extend between the lower graspable rung 4 and the additional graspable rung 9.

FIG. 5a shows a supporting device 3 having two supporting posts and a ladder portion 16 with three graspable rungs; a lower graspable rung 4, an upper graspable rung 5 and an additional graspable rung 9 placed above the upper graspable rung 5. The holder 6 is positioned at a central position of the lower graspable rung 4 and comprises a mechanical stop portion 12. The holder 6 projects towards the upper graspable rung 5 such that a gap is formed between the mechanical stop portion and the upper graspable rung 5. A graspable bar 10 extends between the upper graspable rung 5 and the additional graspable rung 9.

FIG. 5b shows a supporting device 3 having two supporting posts 8 and a ladder portion 16 with two graspable rungs; a lower graspable rung 4 and an upper graspable rung 5. The holder 6 is positioned at a central position of the lower graspable rung 4 and projects towards the upper graspable rung 5. The holder 6 comprises two pins with projecting ends 7. The pins are arranged in a V-configuration. A gap is formed between the projecting ends 7 and the upper graspable rung 5.

FIGS. 6a and 6b show close ups of the ladder portions of the supporting devices shown in FIG. 2 and FIG. 5a.

FIG. 7 shows an embodiment of a system according to the present invention. The system comprises an aid device 1 according to any of the embodiments described above and a user belt 20. The user belt 20 comprises two support bands 21 for supporting the waist, hips and upper part of the legs of the user. User belts 20 comprising one or other numbers of support band are also conceivable. The user belt 20 further comprises a belt strap arrangement 22 for securing the belt to the user. The belt strap arrangement 22 is arranged such that the circumference of the belt is adjustable to the size of the user. In the shown, preferred, embodiment the belt strap arrangement 22 is further arranged to be pulled over and/or around the holder 6 of the aid device 1, thus securing the user to the aid device. The belt 20 may in alternative embodiments be provided with separate straps for securing the belt 20 to the holder 6. A system where the belt strap arrangement 22 is arranged both to secure the belt to the user and to be pulled over and/or around the holder 6, however provides several advantages. The manufacture of a belt with only one belt strap arrangement is easier than the manufacture of belts with several straps having different functions. A belt with fewer straps is also more durable. Further, a belt with fewer straps is much more easy to use for the user and the assisting person during the raising, rotation and transfer.

The aid device 1 according to the invention can be used in the following manner when a disabled or elderly person, i.e. user, lies in bed and needs assistance to be transferred to a wheel chair or to go to the toilet.

The assistant person helps the user to sit up on the edge of the bed and then provides the user with a belt around his waist, seat and/or lumbar area, the belt being arranged with straps. The assistant person then positions the aid device 1 appropriately in front of the user. If the graspable rungs 4,5,9 and/or the lower-leg supports are not properly situated with regard to the specific user, the assistant person adjusts them by means of locking levers or the like. Subsequently the user places his feet on the base plate 1 and then grasps the graspable rungs 4, 5, 9 and/or graspable bars 10 and pulls himself into standing. The assisting person may further help the user during the raising by stabilizing the belt, e.g. by means of supporting handles 24. Once the person is standing the straps of the belt can easily be pulled over the holder 6, such that the user is securely supported by the supporting device 3. The belt strap is preferably adjustable in order to adjust the circumferential size of the belt and thus to adjust the belt around the user, thereby the length of the belt may adjusted once it has been pulled over the holder 6. Alternatively, the strap may first be pulled over the holder 6 already when the user is sitting. The user may then rise, either partly or fully to the upright position, after which the length of the strap, and thus the circumferential size of the belt, is adjusted to securely support the user to the holder 6 and the supporting device 3 in the standing or almost standing position. The user may further be supported by leaning against and/or holding on to the graspable rungs 4, 5, 9. When the user is steady the assistant person may turn the aid device 1 and/or transfer the aid device over the floor, e.g. by means of moving handles 13, by means of the graspable rungs 4, 5, 9, or by means of the ladder portion 16 or supporting posts 8. When the wheel chair or toilet is reached the strap may again be easily released from the handle 6, before the user uses the graspable rungs 4, 5, 9 and/or assistance from the assistant person to sit down.

Within the scope of the invention, the aid device can be used in many other situations, such as in transfer to/from an armchair or in transfer to/from a dining area.

Although exemplary embodiments of the present invention has been shown and described, it will be apparent to the person skilled in the art that a number of changes and modifications, or alterations of the invention as described herein may be made. The person skilled in the art realizes that the exact shape of the ladder portion is not limited to the embodiments shown above. Thus, it is to be understood that the above description of the invention and the accompanying drawing is to be regarded as a non-limiting example thereof and that the scope of the invention is defined in the appended patent claims.

1. An aid device for raising, rotation and transfer of a user, comprising a base plate for placement of the feet of the user and a supporting device connected to the base plate for supporting the user during the raising, rotation and/or transfer, said supporting device comprising;
a ladder portion having at least a first and a second graspable rung for aiding the user during the raising, rotation and/or transfer; and
a holder for releasably holding a strap connected to the user, wherein the holder projects from the first graspable rung towards the second graspable rung such that a gap is formed between a projecting end of the holder and the second graspable rung.

2. The aid device of claim 1, wherein the gap comprises a width sufficiently narrow to prevent the strap from unintentionally being released from the holder during the raising, rotation and/or transfer.

3. The aid device of claim 1, wherein the width of the gap is approximately 0.5-2 cm.

4. The aid device of claim 1, wherein the holder comprises a pin, peg, catch or any protruding portion attached to the first graspable rung.

5. The aid device of claim 1, wherein the holder comprises two pins, pegs, catches or protruding portions attached to the first graspable rung and that are arranged in a V-shaped configuration.

6. The aid device of claim 1, wherein the holder further comprises a mechanical stop portion for preventing the strap from being unintentionally released from the holder.

7. The aid device of claim 6, wherein the mechanical stop portion is arranged at the projecting end.

8. The aid device of claim 6, wherein the mechanical stop portion comprises an element having a cross section area larger than that of a main holding portion of the holder or a hook.

9. The aid device of claim 1, wherein the holder projects substantially perpendicularly from the first graspable rung.

10. The aid device of claim 1, wherein the supporting device comprises a supporting post which at one end is connected to the base plate and at the other end comprises the ladder portion.

11. The aid device of claim 1, wherein the supporting device comprises two parallel supporting posts which at one end are connected to the support base, and at the other end comprise said graspable rungs extending between said supporting posts thereby forming the ladder portion.

12. The aid device of claim 10, wherein the supporting post(s) is/are detachably connected to the base plate.

13. The aid device of claim 10, wherein the supporting post(s) is/are rigidly connected to the base plate.

14. The aid device of claim 1, wherein the ladder portion further comprises at least one graspable bar interconnecting the graspable rungs of the ladder portion.

15. A system for raising, rotation and transfer of a user, comprising an aid device according to claim 1 and a user belt arranged to be secured to the holder of the aid device.

16. The system of claim 15, wherein said user belt comprises at least one support band for supporting the waist of the user.

17. The system of claim 15, wherein said user belt comprises a belt strap arrangement for securing the belt to the user and wherein the belt strap arrangement is adjustable to the size of the user.

18. The system of claim 17, wherein said belt strap arrangement further is arranged to be pulled over and/or around said holder during the raising, rotation and/or transfer of a user.

19. The aid device of claim 2, wherein the width of the gap is approximately 0.5-2 cm.

20. The aid device of claim 2, wherein the holder comprises a pin, peg, catch or any protruding portion attached to the first graspable rung.
